(19) United States
(12) Patent Application Publication
(10) Pub. No.: US 2025/0371517 A1
(43) Pub. Date: Dec. 4, 2025

(54) PAY PER INTRODUCTION FEATURE WITH DATING APP

(71) Applicant: Andrea Miller, San Diego, CA (US)

(72) Inventor: Andrea Miller, San Diego, CA (US)

(21) Appl. No.: 18/679,511

(22) Filed: May 31, 2024

(51) Int. Cl. G06Q 20/32; G06Q 20/40; G06Q 50/00; H04L 51/52

(52) U.S. Cl. CPC G06Q 20/3267; G06Q 20/407; G06Q 50/01; H04L 51/52

(57) ABSTRACT

According to an aspect of the present invention, [briefly describe your invention].

### BACKGROUND

The present invention relates generally to the field of online dating and matchmaking services. More specifically, the invention relates to methods and systems for facilitating user interactions and enabling direct communication between matched users within a dating application.

Online dating platforms have become increasingly popular in recent years as a means for individuals to connect with potential romantic partners. These platforms typically allow users to create profiles highlighting their interests, preferences, and personal information, and to browse the profiles of other users to find potential matches.

However, a common problem faced by users of online dating services is the difficulty in transitioning from initial match to meaningful conversation and interaction. Users may be hesitant to invest time and effort into communicating with a match without some indication of mutual interest and commitment.

Existing dating platforms have attempted to address this issue in a variety of ways. For example, some platforms require users to “like” or express interest in each other before any communication can occur. Others allow users to send a limited number of messages to potential matches for free, before requiring a paid subscription to continue communicating.

One such example is described in U.S. Pat. No. 9,733,811, entitled “Matching Process System and Method.” This patent discloses a method for profile matching that includes receiving user profiles, receiving a preference indication for a first user profile, determining a potential match user profile based on the preference indication, and presenting the potential match user profile to a second user.

However, these existing solutions do not adequately address the underlying hesitancy and lack of commitment that can prevent users from engaging in meaningful communication after an initial match is made. There remains a need for a dating platform that facilitates and encourages more deliberate and intentional user interactions by requiring a mutual investment from both parties.

The present invention addresses this need by providing a method and system for enabling direct communication between matched users within a dating application only after both users have submitted a payment. By requiring an upfront financial commitment from both parties, the platform ensures that users are serious about pursuing the connection and are willing to invest in the potential relationship.

In summary, the present invention represents a significant improvement over existing online dating platforms by providing a novel method and system for facilitating user interactions and enabling direct communication between matched users. By requiring mutual investment and providing clear status indicators, the invention encourages more deliberate and meaningful user connections while addressing the common problem of user hesitancy and lack of commitment.

### SUMMARY

In an embodiment, a computer-implemented method for facilitating user interactions within a dating application is disclosed. The method includes receiving an indication of a mutual match between a first user and a second user of the dating application. In response to the mutual match, the method requires both users to submit a payment of a predetermined value to enable direct communication. Upon receiving payment from the first user, a time window is initiated during which the second user must submit payment. If the second user submits payment within the time window, direct communication is enabled between the users within the application. If the second user does not submit payment within the time window, the first user's payment is refunded and the mutual match is removed.

The method may further include displaying various status indicators to the users. A first status indicator, visible to the first user, may indicate that the first user has submitted payment while the second user has not. This indicator may include a countdown timer showing the time remaining for the second user to submit payment. A second status indicator, visible to the second user, may indicate that the second user has submitted payment while the first user has not. A third status indicator may be displayed to both users once both payments have been submitted, confirming that direct communication is now enabled.

The predetermined payment value may be based on packages of virtual coins purchased by the users. The payment value may also vary based on user subscription tiers, number of previous connections, or profile desirability scores.

In another embodiment, a system for facilitating user interactions within a dating application is disclosed. The system includes a server configured to perform the steps of the method described above. The server is further configured to enable users to purchase payment credits in advance, deducting payment from these pre-purchased credits when a user initiates or reciprocates communication. The server may also provide refunds to users if the counterparty fails to submit timely payment or fails to engage in communication after payment.

Enabling direct communication between matched users may include moving their conversation into a dedicated chat interface within the dating application. The time window for the second user to submit payment after the first user may be a defined duration, such as 48 hours.

The present invention represents an improvement over existing online dating platforms, addressing the problem of user hesitancy and lack of commitment after an initial match by requiring mutual investment before enabling direct communication. The method and system encourage more deliberate and meaningful user interactions by facilitating a mutual financial commitment and providing clear status indicators throughout the process.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates an embodiment of the overall system architecture for facilitating user interactions within a dating application.

FIG. 2 depicts an embodiment of a flow chart of the process for handling a mutual match.

FIG. 3A depicts a user registration and profile creation interface of a dating application, comprising input fields and selection menus for users to provide requisite information and set preferences.

FIG. 3B illustrates an embodiment of the dating application interface showing a “Search” tab, wherein a user swiping right on a profile causes the server to determine a “like” has occurred and store the “like” in a database.

FIG. 3C shows an embodiment of the dating application interface with a “My Lists” tab and a “My Matches” tab displaying user matches, and an indicator on matched profiles requiring payment to enable communication, such as “Pay to Talk” text.

FIG. 3D depicts an embodiment of the dating application prompting a user to send an initial message and coin payment to start a conversation.

FIG. 3E illustrates an embodiment of the dating application interface displaying a countdown timer on the first user's profile to the second user.

FIG. 3F depicts an embodiment of the dating application interface moving the match into a “Chat” tab and deducting the coin payment from the first user's coin balance.

FIG. 3G shows an embodiment of the dating application interface on the second user's client device, displaying a red countdown timer indicating the first user has paid but the second user has not.

FIG. 3H illustrates an embodiment of the dating application opening the conversation and allowing users to send unlimited messages to each.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

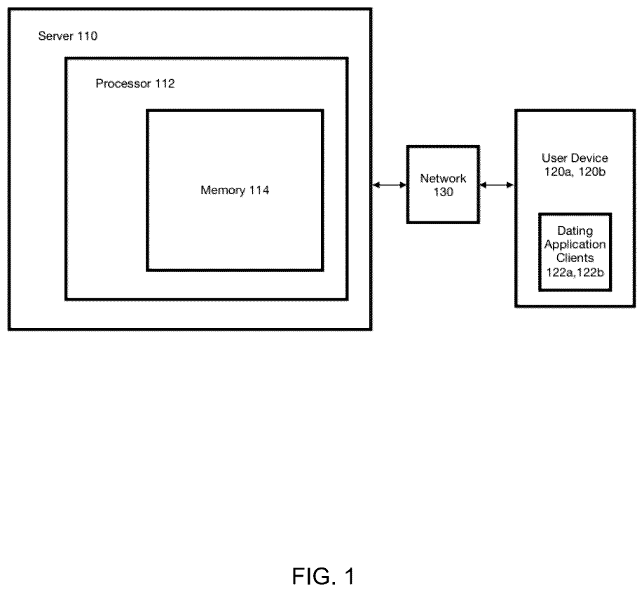

FIG. 1 illustrates the overall system architecture for facilitating user interactions within a dating application. The system includes a server 110 comprising at least a processor 112, a memory 114, and a network interface device 116. The server 110 is configured to communicate with user devices 120a and 120b over a network 130, such as the Internet or a cellular network.

The processor 112 may be a multi-core CPU such as an Intel Xeon or AMD Ryzen processor, capable of executing instructions stored in the memory 114. The memory 114 may include both volatile memory, such as RAM, and non-volatile memory, such as an SSD or HDD, for storing executable instructions, user data, and application data. The network interface device 116 may be an Ethernet adapter, Wi-Fi module, or cellular modem that enables communication between the server 110 and the user devices 120a and 120b.

User devices 120a and 120b may be smartphones, tablets, or personal computers with dating application clients 122a and 122b installed. The dating application clients 122a and 122b provide a user interface for users to create profiles, view potential matches, indicate mutual interest, and communicate with matched users. The dating application clients 122a and 122b communicate with the server 110 to send user actions and receive updates, such as match notifications and chat messages.

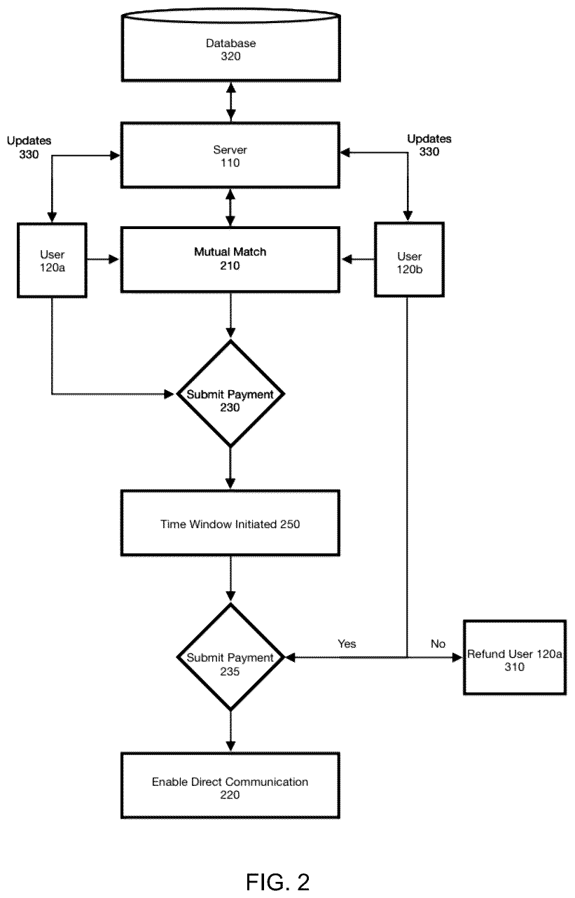

FIG. 2 depicts a flow chart of the process for handling a mutual match 210 and enabling direct communication 220 between matched users. The process begins when the server 110 receives an indication of a mutual match 210 between a first user 120a and a second user 120b of the dating application.

In response to the mutual match 210, the server 110 requires both users 120a, 120b to submit a payment 230 of a predetermined value to enable direct communication 220. The payment value may be based on a package of virtual coins or credits 240 purchased by the users 120a, 120b. Users can purchase these coins or credits (not shown) in advance, and the server 110 deducts the required payment 230 from their balances.

Upon receiving payment 230 from the first user 120a, the server 110 initiates a time window 250 during which the second user 120b must also submit payment 235. The time window 250 may be a predetermined duration, such as 48 hours. The server 110 monitors the payment status of the second user 120b during this window.

If the second user 120b submits the required payment 235 within the time window 250, the server 110 enables direct communication 220 between the two users 120a, 120b within the dating application. This may involve moving their conversation to a dedicated chat interface. The chat interface may utilize WebSocket protocol for real-time communication or a RESTful API for sending and retrieving messages.

However, if the second user 120b fails to submit payment 235 within the time window 250, the server 110 refunds the payment 310 to the first user 120a and removes the mutual match 210. The server 110 may also provide a refund to the second user 120b if they submit payment 230 but the first user 120a fails to engage in communication within a predetermined time period. The server 110 manages these refund scenarios by updating user balances and sending notifications.

Throughout this process, the server 110 logs relevant events and data 320 in a database, such as PostgreSQL or MongoDB, for tracking user interactions and debugging purposes. The dating application clients, periodically fetch updates 330 from the server 110 to reflect the current state of user matches and conversations.

By implementing this mutual match 210 and payment process 230, the dating application encourages users 120a, 120b to be more invested in their interactions and reduces the likelihood of unresponsive or uninterested matches. The system architecture and flow chart work together to provide a seamless user experience while ensuring fair and balanced communication 220 between matched users 120a, 120b.

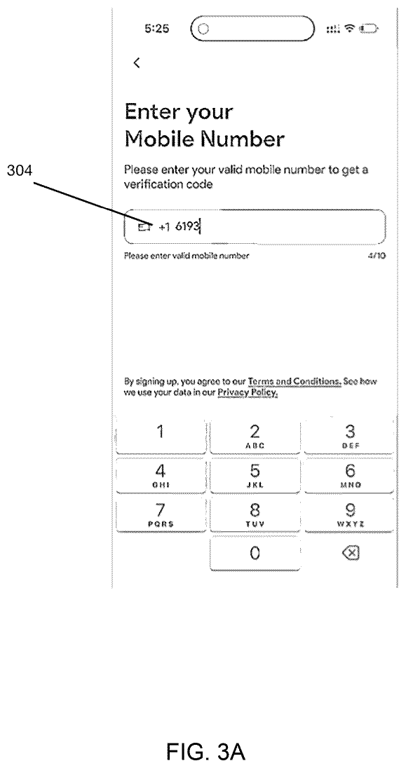

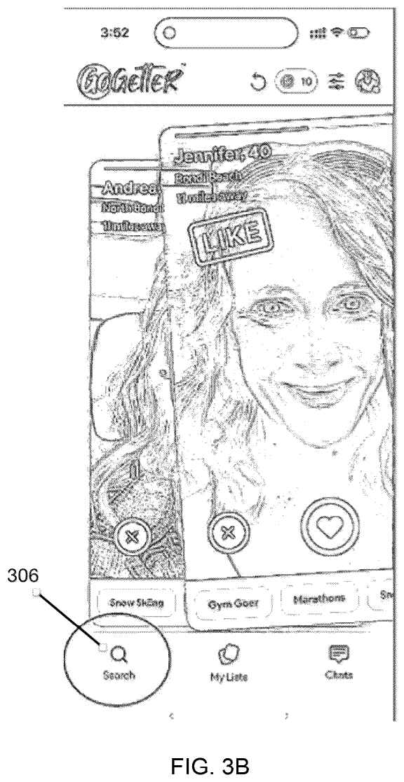

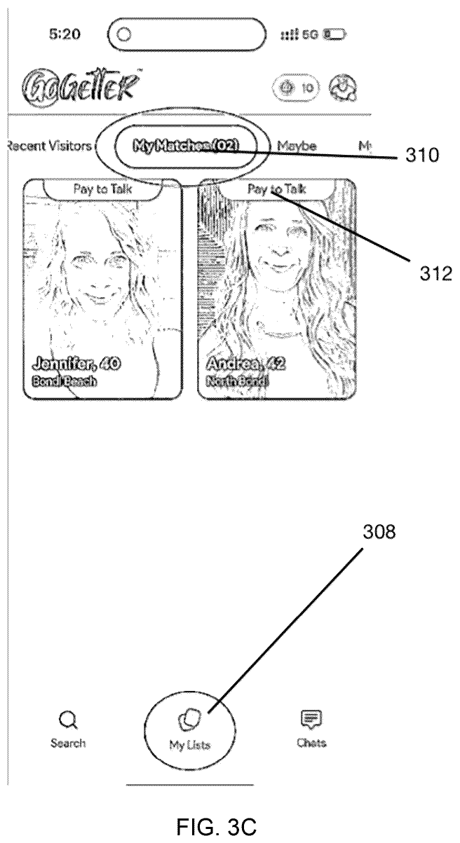

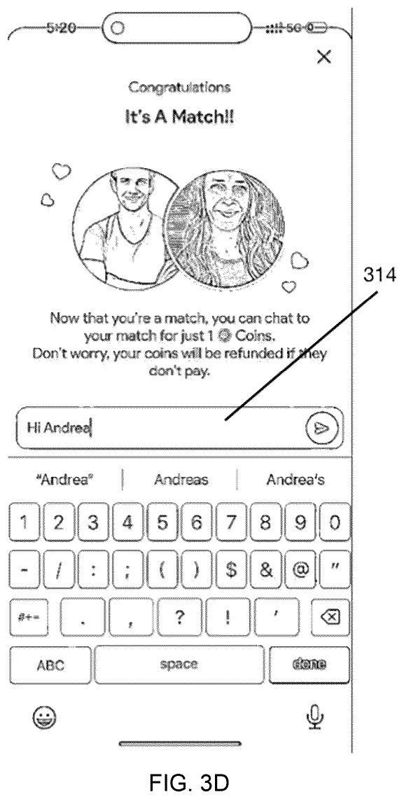

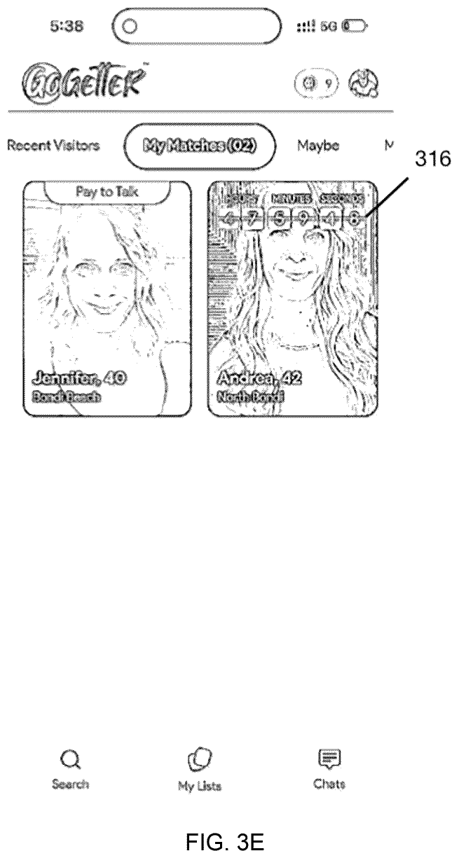

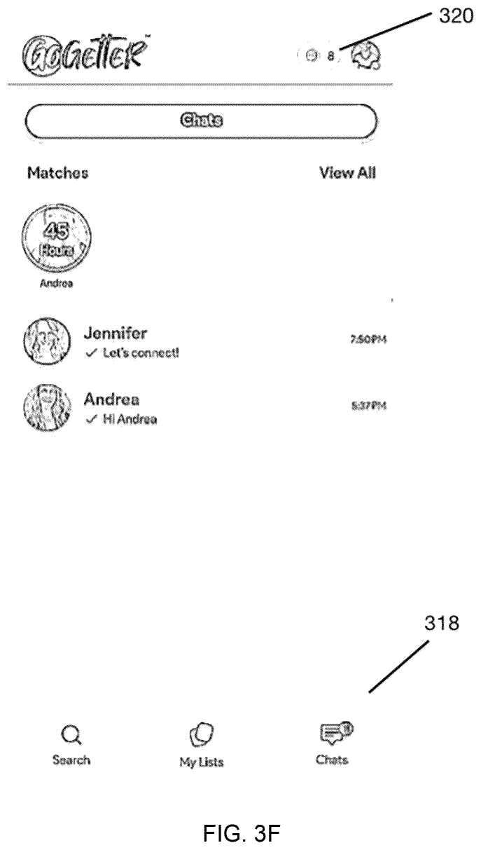

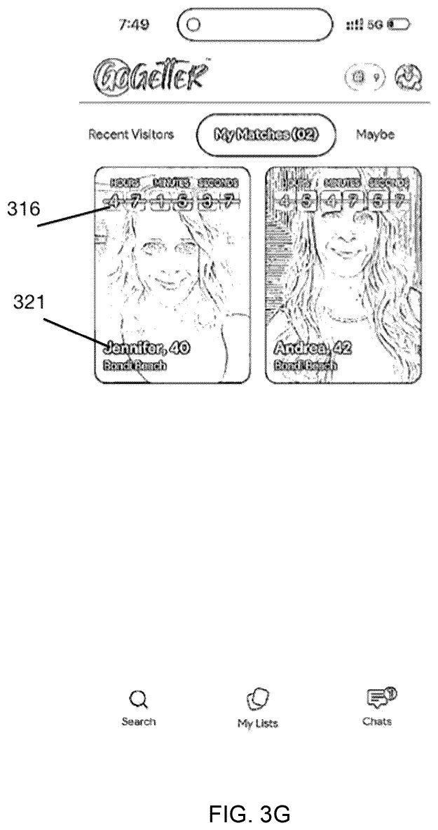

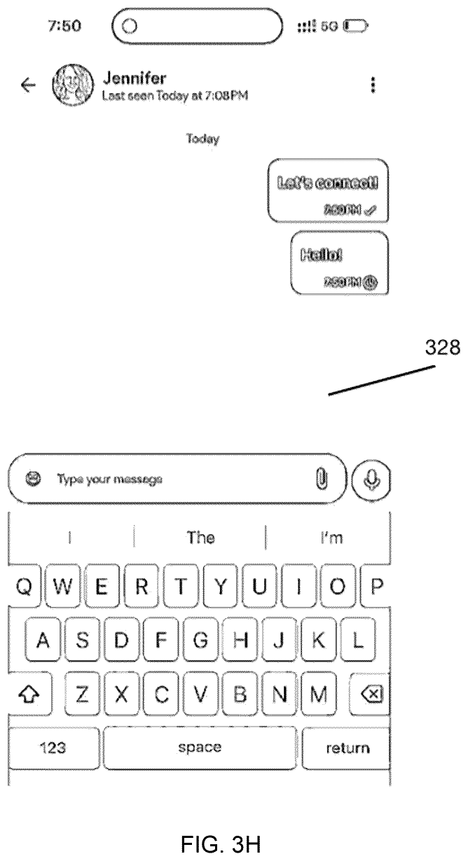

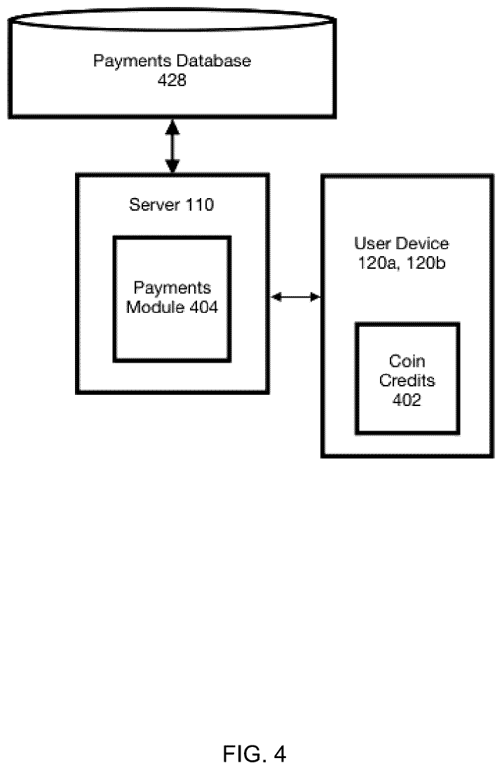

FIG. 3 illustrates an exemplary user interface flow within the dating application for facilitating direct communication between matched users. The user interface flow comprises a series of screen interfaces, FIG. 3A through FIG. 3H, presented in chronological order.

FIG. 3A depicts a user registration and profile creation interface. Users sign up for the dating application by providing requisite information and setting their preferences via input fields and selection menus 304. The server 110, receives and stores the user registration data.

FIG. 3B depicts that when users swipe right on a profile, the server 110 determines that a “like” has occurred and stores the “like” in a database (not shown). This “like” action occurs within the “Search” tab 306 of the dating application interface.

Moving to FIG. 3C, match 210 between users are displayed in a “My Lists” tab 308 and a “My Matches” tab 310 of the dating application interface. If neither user in a match 210 has paid a predetermined fee or coin, the server 110 displays an indicator on the matched profile that payment 230 is required to enable communication, for example “Pay to Talk” 312 in yellow text.

In FIG. 3D, to start a conversation with a match 210, the dating application requires a user to pay a coin. The user can tap on the matched profile which causes the client device 130 to display a prompt for the user to send an initial message 314. Upon receiving the message and coin payment 230 from a first user, the server 110 initiates a time window 250 during which the second user must also submit payment to enable further communication between the users. The server 110 stores these payment transactions in a payments database (not shown).

Referring to FIG. 3E, upon receiving the first user's payment 230, the server 110 causes the client device 130 of the second user to display a status indicator on the first user's profile with a countdown timer 316 showing the time remaining for the second user to also submit payment. This countdown timer 316 may be blue in color.

In FIG. 3F, the server 110 moves the match 210 into a “Chat” tab 318 and deducts the coin payment 230 from the first user's coin balance 320. The server 110 notifies the first user whether the second user has submitted payment. If the second user does not pay within the time window 250, the server 110 refunds the coin to the first user.

FIG. 3G illustrates the interface on the second user's client device 130. The server 110 displays the countdown timer 316 in red to indicate that the first user has paid but the second user has not. Tapping the first user's profile 321 causes the client device 130 to remind the second user that the first user has already paid (not shown). Tapping the second user's own profile causes the client device 130 to prompt the second user to submit payment 235 by sending an initial message similar to FIG. 3D. Once the second user submits payment 235 within the time window 250, the server 110 moves the match 210 into the “Chat” tab 318 and removes it from the “Matches” section 310.

Finally, in FIG. 3H, after both users have submitted coin payments 230, 235, the server 110 opens the conversation and allows the users to send unlimited messages to each other via a chat interface 328. The server 110 may display a status indicator that messaging is enabled.

FIG. 4 illustrates the payment credit purchasing and variable pricing functionality. The server 110 allows users on user devices 120a, 120b to purchase coin credits 402 in advance via a payments module 404. When a user initiates communication with a match 210, the payments module 404 deducts the required coin payment from the user's pre-purchased credit balance stored in the payments database 428. The payments module 404 may adjust the price per coin based on factors comprising the user's subscription tier, number of previous connections. The server 110 can present the pricing and coin balance 406 to users via a user interface on the client devices 120a, 120b.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for facilitating user interactions within a dating application, the method comprising:
receiving, by a server, an indication of a mutual match between a first user and a second user of the dating application;
in response to receiving the indication of the mutual match, requiring, by the server, both the first user and the second user to submit a payment of a predetermined value to enable direct communication between the first user and the second user;
upon receiving the payment from the first user, initiating, by the server, a time window during which the second user is required to submit the payment;
if the second user submits the payment within the time window, enabling, by the server, direct communication between the first user and the second user within the dating application; and
if the second user does not submit the payment within the time window, refunding, by the server, the payment to the first user and removing the mutual match between the first user and the second user.

2. The method of claim 1, wherein the predetermined value of the payment is based on a package of coins purchased by the first user and the second user.

3. The method of claim 1, further comprising:
displaying, by the server, a first status indicator on a profile of the second user visible to the first user, the first status indicator indicating that the first user has submitted the payment and the second user has not yet submitted the payment.

4. The method of claim 3, wherein the first status indicator includes a countdown timer indicating an amount of time remaining in the time window for the second user to submit the payment.

5. The method of claim 4, wherein the countdown timer is displayed in a first color.

6. The method of claim 1, further comprising:
displaying, by the server, a second status indicator on a profile of the first user visible to the second user, the second status indicator indicating that the second user has submitted the payment and the first user has not yet submitted the payment

7. The method of claim 6, wherein the second status indicator includes a countdown timer indicating an amount of time remaining in the time window for the first user to submit the payment, and wherein the countdown timer is displayed in a second colordifferent from the first color.

8. The method of claim 1, further comprising:
displaying, by the server, a third status indicator on profiles of the first user and the second user after the first user and the second user have both submitted the payment, the third status indicator indicating that direct communication is enabled between the first user and the second user.

9. The method of claim 1, wherein enabling direct communication between the first user and the second user comprises:
moving, by the server, a conversation between the first user and the second user into a chat interface of the dating application.

10. The method of claim 1, wherein the time window is 48 hours in duration.

11. A system for facilitating user interactions within a dating application, the system comprising:
a server comprising at least a processor, a memory, and a network interface device;
the server configured to:
receive an indication of a mutual match between a first user and a second user of the dating application;
in response to receiving the indication of the mutual match, require both the first user and the second user to submit a payment of a predetermined value to enable direct communication between the first user and the second user;
upon receiving the payment from the first user, initiate a time window during which the second user is required to submit the payment;
if the second user submits the payment within the time window, enable direct communication between the first user and the second user within the dating application; and
if the second user does not submit the payment within the time window, refund the payment to the first user and remove the mutual match between the first user and the second user.

12. The system of claim 11, wherein the server is further configured to:
display a first status indicator on the first user's profile visible to the second user before the first user has submitted the payment, the first status indicator indicating that the first user has not yet paid to communicate with the second user;
upon receiving the payment from the first user, update the first status indicator to a second status indicator indicating to the second user that the first user has paid and a payment from the second user is now required to enable communication; an
display a countdown timer to the second user indicating the time remaining in the time window for the second user to submit the payment

13. The system of claim 12, wherein the server is further configured to:
upon receiving the payment from the second user within the time window, update the second status indicator to a third status indicator confirming that both the first user and second user have paid and direct communication is now enabled.

14. The system of claim 11, wherein the server is further configured to:
enable the first user and second user to purchase payment credits in advance;
deduct the payment from the first user's pre-purchased payment credits upon receiving instruction from the first user to initiate communication with the second user; and
deduct the payment from the second user's pre-purchased payment credits upon receiving the payment from the second user within the time window.

15. The system of claim 11, wherein the predetermined value of the payment varies based on one or more of:
a type or tier of subscription of the first user or the second user;
a number of previous connections made by the first user or the second user;
and a profile desirability score of the first user or the second user

16. The system of claim 11, wherein the server is further configured to:
provide a first refund of the payment to the first user if the second user does not submit the payment within the time window; and
provide a second refund of the payment to the second user if the second user submits the payment within the time window but the first user fails to engage in communication with the second user within a predetermined time period.

17. The system of claim 11, wherein the predetermined value of the payment is based on a package of coins purchased by the first user and the second user.

18. The system of claim 11, wherein the server is further configured to:
display a second status indicator on a profile of the first user visible to the second user, the second status indicator indicating that the second user has submitted the payment and the first user has not yet submitted the payment.

19. The system of claim 18, wherein the second status indicator includes a countdown timer indicating an amount of time remaining in the time window for the first user to submit the payment, and wherein the countdown timer is displayed in a second color different from a first color used for a countdown timer displayed to the second user.

20. The system of claim 11, wherein the server is further configured to:
display a third status indicator on profiles of the first user and the second user after the first user and the second user have both submitted the payment, the third status indicator indicating that direct communication is enabled between the first user and the second user.

21-22. (canceled)
